(19) United States
(12) Patent Application Publication
(10) Pub. No.: US 2013/0036193 A1
(43) Pub. Date: Feb. 7, 2013

(54) SYSTEM AND METHOD FOR GENERATING DYNAMIC IMAGE SPRITES

(71) Applicant: Senthil Padmanabhan, Campbell, CA (US)

(72) Inventor: Senthil Padmanabhan, Campbell, CA (US)

(73) Assignee: eBay Inc., San Jose, CA (US)

(21) Appl. No.: 13/535,942

(22) Filed: Jun. 28, 2012

Related U.S. Application Data
(60) Provisional application No. 61/505,498, filed on Jul. 7, 2011.

(51) Int. Cl. G06F 15/16

(52) U.S. Cl. 709/217

(57) ABSTRACT

A method, system, and article of manufacture for receiving a call from a client device to execute a web service after a web page is loaded by the web browser application, the call including a plurality of image uniform resource identifiers (URI), generating, by at one processor executing the web service, a dynamic image sprite using the image URIs, the dynamic image sprite comprising a base-64 encoded image data URI scheme response in JavaScript Object Notation format, and transmitting the dynamic image sprite to the client device.

### CROSS-REFERENCE TO RELATED APPLICATIONS

This application claims the benefit of U.S. Provisional Application No. 61/505,498, filed Jul. 7, 2011, which is incorporated herein by reference in its entirety.

### TECHNICAL FIELD

Example embodiments of the present disclosure relate generally to web page rendering, and specifically, to a system and method for improving the rendering speed of a web page.

### BACKGROUND

Web pages are documents generally written in a markup language (e.g., HyperText Markup Language (HTML), eXtensible HyperText Markup Language (XHTML)) that contain text, images, and other content (e.g., audio, video, user-selectable user interface elements, hyperlinks). A web page document also may include or may reference web page display information (e.g., layout, color scheme, typography). Together, the content and the display information may be used to render a web page in a format capable of being displayed on a screen. To render a web page, a web browser will retrieve a markup language document and pass the document to a browser rendering engine that transforms the markup language into formatted content suitable for viewing on a display. In certain instances, to render content that is referenced (by a uniform resource identifier (URI), for example) within the markup language document, the web browser navigates to the information resource pointed to by the URI and retrieves the referenced content for display within the web page. In these cases, the web browser may need to issue a Hypertext Transfer Protocol (HTTP) request to retrieve the content located at the network address pointed to by the URI. If a web page has multiple content items that cause a web browser to issue multiple HTTP requests, the speed at which the web page is rendered by the web browser can be diminished, thereby hampering the user experience of viewing the web page.

### BRIEF DESCRIPTION OF THE DRAWINGS

Example embodiments of the present disclosure are illustrated by way of example, and not by way of limitation, in the figures of the accompanying drawings.

FIG. 1 is a diagram depicting a network system, according to one embodiment, having a client-server architecture configured for exchanging data over a network.

FIG. 2 illustrates an example method of generating a dynamic image sprite, according to some embodiments.

FIG. 3 illustrates a diagram of a system 300 for generating dynamic image sprites, according to some embodiments.

FIG. 4 shows a diagrammatic representation of a machine in the example form of a computer system within which a set of instructions may be executed to cause the machine to perform any one or more of the methodologies discussed herein.

### DETAILED DESCRIPTION

Systems, methods, and machine-readable storage media storing a set of instructions for improving the rendering speed of a web page are disclosed. In the following description, for purposes of explanation, numerous specific details are set forth in order to provide a thorough understanding of the present disclosure. It may be evident, however, to one skilled in the art that the subject matter of the present disclosure may be practiced without these specific details.

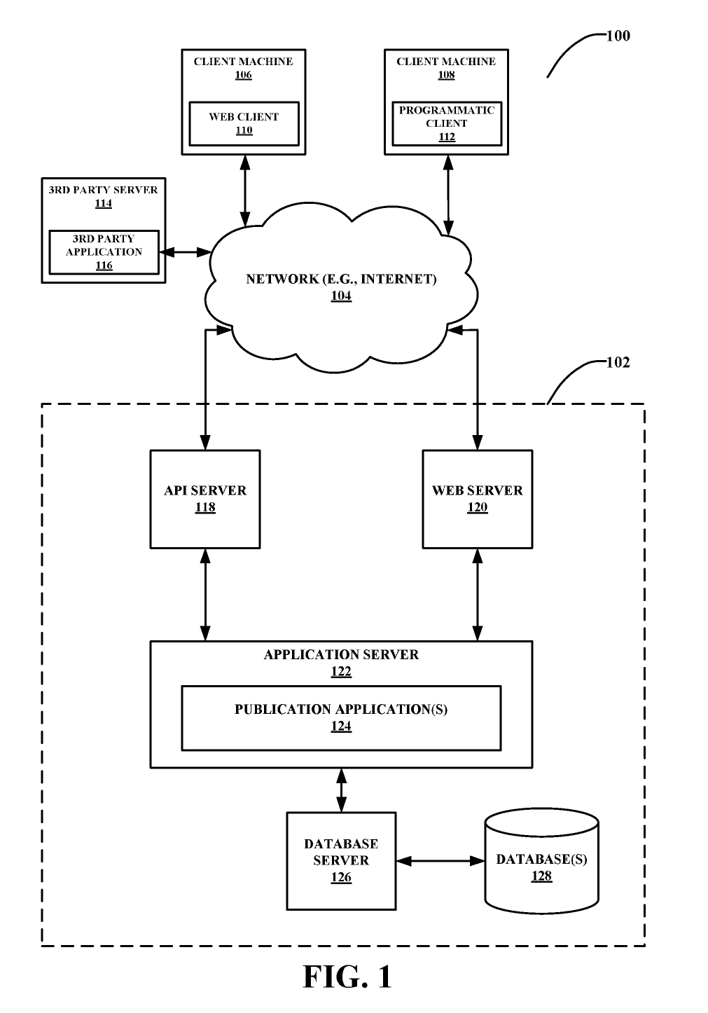

FIG. 1 is a network diagram depicting a network system 100, according to one embodiment, having a client-server architecture configured for exchanging data over a network. For example, the network system 100 may be a publication/publisher system 102 where clients may communicate and exchange data within the network system 100. The data may pertain to various functions (e.g., selling and purchasing of items) and aspects (e.g., data describing items listed on the publication/publisher system) associated with the network system 100 and its users. Although illustrated herein as a client-server architecture as an example, other example embodiments may include other network architectures, such as a peer-to-peer or distributed network environment.

A data exchange platform, in an example form of a network-based publisher 102, may provide server-side functionality, via a network 104 (e.g., the Internet) to one or more clients. The one or more clients may include users that utilize the network system 100 and more specifically, the network-based publisher 102, to exchange data over the network 114. These transactions may include transmitting, receiving (communicating) and processing data to, from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server 114 hosting a third party application 116. It can be appreciated in various embodiments the client machine 106, 108, or third party application 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

Turning specifically to the network-based publisher 102, an application program interface (API) server 118 and a web server 120 are coupled to, and provide programmatic and web interfaces respectively to, one or more application servers 122. The application servers 122 host one or more publication application (s) 124. The application servers 122 are, in turn, shown to be coupled to one or more database server(s) 126 that facilitate access to one or more database(s) 128.

In one embodiment, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., client application 112 or third party application 116) running on another client machine (e.g., client machine 108 or third party server 114).

The publication application(s) 124 may provide a number of publisher functions and services (e.g., search, listing, payment, etc.) to users that access the network-based publisher 102. For example, the publication application(s) 124 may provide a number of services and functions to users for listing goods and/or services for sale, searching for goods and services, facilitating transactions, and reviewing and providing feedback about transactions and associated users. Additionally, the publication application(s) 124 may track and store data and metadata relating to listings, transactions, and user interactions with the network-based publisher 102.

FIG. 1 also illustrates a third party application 116 that may execute on a third party server 114 and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher or payment functions that are supported by the relevant applications of the network-based publisher 102.

In some embodiments, a system, method, and machine-readable storage medium storing a set of instructions for generating a dynamic image sprite are disclosed. The dynamic image sprite may reduce the number of HTTP requests to retrieve web page images required to be issued by a web browser application while handling dynamic image sets that may change with every user request for a given web page.

In some embodiments, image spriting is used as a technique to speed up the rendering of a page. A sprite may be a transparent computer art graphic that can change position and move around a display screen while not affecting the background behind the graphic. A computer graphics sprite may be a two-dimensional or three-dimensional image or animation that is integrated into a larger scene. The sprite may include user adjustable dynamic visual elements. Some programming languages allow the creation of sophisticated interactive movies and allow a user to interact with the animation by manipulating sprites in the movie, triggering changes in the movie by clicking on a sprite, or even by opening a web site in a browser window. Often sprites are uploaded into a picture server in a desired format, for example as a transparent Portable Networks Graphic (PNG). The transparency aids in applying a background color using, for example, Cascading Style Sheets (CSS), as necessary to imply different states of the same image, for example, hover state, selected state. The user or developer could then point to each category using pixel co-ordinates as locations. Sprite sheet generation tools are becoming more common because game development for devices and the web is currently a big business and sprite sheets are used in a lot of game development engines. Examples of sprite sheet generation tools found on Internet are TexturePacker™, Zwoptex™ and SWFSheet.

In general a sprite sheet comprises two pieces. The first piece is a packed sequence of images that describes one or more animation sequences. Most game/animation sequence engines use common image formats like png, JPEG XR or a JPEG with a mask to import the image data. Extensible image format generation is known and does not need to be addressed in detail.

The second piece of a sprite sheet comprises one or more data files. The most common piece of information stored in these data files is a list of frames and the location of each frame (generally a pixel based bounding box) within the generated image. The most commonly used file formats used to store this information is xml, plist and JSON. This file may be called the sprite sheet frame layout file. In general, CSS may be used to select the parts of the composite image of a sprite sheet to display at different points in a page. For example, if a page has ten 1 kb images, they can be combined into one 10 kb image, downloaded with a single HTTP request, and then positioned with CSS. Reducing the number of HTTP requests can make a Web page load faster. This enables the sprite sheet format that had been developed for use in game and animation engines is being applied to static images. That is, as used herein an image may be a collection of images, such as a sprite sheet, consolidated into a single image, such as a single image sprite. By consolidating images into a single image sprite, the number of HTTP requests required to retrieve images for rendering on a web page may be reduced, thereby improving the speed and performance of the web page. CSS Image Sprites are now commonly used to remove the performance problems created by making separate HTTP requests for every image on a web page. Unfortunately, the technique cannot be used on a web page with a dynamic image set such as an eBay search results page because the images on the page change with every request, or most requests, based on the item specifics. Therefore, combining dynamic images into one sprite image is generally not possible.

In some embodiments, an image Data URI scheme may be used to combine dynamic images into a CSS image sprite. A Data URI scheme refers to a URI scheme in which data is included in-line in web pages as if the data were external resources. Additional details concerning the Data URI scheme may be found in Request for Comments (RFC) 2397 of the Internet Engineering Task Force. A benefit of the Data URI scheme is that it is supported by all major browsers (except Microsoft Internet Explorer (IE) 6 and 1E7). A further benefit is that the Data URI scheme solves the problem of issuing too many HTTP calls to retrieve dynamic images for display on a web page, such as a search results page. In some embodiments, the code for a Data URI scheme is represented as: <img id=“item1” src=“data:image/png;base64,<data>” alt=“iPad 2.0”/>

In CSS, the Data URI scheme may be expressed as follows:

#item1 {
background: url(data:image/png;base64,<data>) no-repeat;
}

Though the Data URI scheme solves the original problem of too many http calls, it may create two additional problems. First, the use of the Data URI scheme may cause an exponential increase in response HTML payload size, since the dynamic images are now embedded in the page as a result of using the Data URI scheme. Second, use of the Data URI scheme causes a loss of browser cache benefits because all images are sent over the wire on every page request.

To create image sprites dynamically while avoiding the above problems caused by the use of the Data URI scheme, in some embodiments, a simple web service, named urigen, is created to generate a base64-encoded image data URI scheme response in JavaScript Object Notation (JSON) format for a given set of image URLs. One skilled in the art will understand that other types of encoded image data may be used.

Operation

For a page with a dynamic image set, the browser calls the urigen web service immediately or promptly after the page load event with the image URLs passed as GET (or POST) query string parameters. The web service then extracts the image URLs from the query string, makes HTTP calls to the image hosting servers, does a base64 encoding on the response, builds a JSON array and returns it as shown below.

For example, an HTTP request generated by the urigen web service is shown below:

```
    http://hostedserver/services/urigen.PHP?thumbs2.ebaystatic.com/m/
mfqVqeVYnfS8MAHPgpTnINQ/140.jpg&thumbs4.ebaystatic.com/m/
mZScfBs8aQzwcGokxSUV_mQ/140.jpg
    Or
    http://hostedserver/services/urigen.PHP?params={“images”:[“http://
thumbs2.ebaystatic.com/m/mfqVqeVYnfS8MAHPgpTnINQ/140.jpg,
”http://thumbs4.ebaystatic.com/m/mZScfBs8aQzwcGokxSUV_mQ/
140.jpg”]}
```

In response to the HTTP request, the JSON array returned by the web service is shown below:

```
{“data”:
    [
    {“url”:“http:\/\/thumbs2.ebaystatic.com\/m\/home\/images\/
productbrowser\/140.jpg“,”uri“:”\/9j\/4AAQSkZJRgABAgAAZABkAAD\/
........5AQEBAQEBAQEBAQEBAQEBAQEH\/\/z”},
    {“url”:“http://thumbs4.ebaystatic.com/m/
mZScfBs8aQzwcGokxSUV_mQ/140.jpg“,”uri“:”R01GODlhbgAtANUA
ALIAJpnMAAAAmczl.......B4NmdQZTJ5QUFBQUFFbEZUa1N1UW1
DQw==”}
    ]
}
```

A JavaScript engine then de-serializes the JSON response, creates images with the data URI scheme and displays them to the user. This technique (called Data URI sprites) blends image spriting with the Data URI scheme. Multiple image HTTP requests are dynamically combined into one, and there is no need to lay out images ahead of time as is necessary for CSS sprites.

Data URI sprites can be effectively used for dynamic images below the fold on a page, or for images that are shown on demand based on user actions.

### Optimizations

Optimizations in various embodiments may include the JSON response having the appropriate HTTP cache headers to benefit from browser caching, if the same URLs are requested again. If the service is hosted on the same web server that is hosting the images, HTTP calls (from web service to image server) and their associated latency can be avoided and images can be read from the disk locally. The web service may benefit from a proper LRU caching mechanism in place to avoid repetitive calls for the same image and instead retrieve data from the server cache. The service may also be available in JSONP format with a JavaScript callback to enable browser cross domain communication. The urigen web service itself can be a server side call from the page and the data sent as a separate below-fold chunk after the main page is flushed out. Chunked transfer encoding is a data transfer mechanism in version 1.1 of the Hypertext Transfer Protocol (HTTP) in which a web server serves content in a series of chunks. It uses the Transfer-Encoding HTTP response header in place of the Content-Length header, which the protocol would otherwise require. Because the Content-Length header is not used, the server does not need to know the length of the content before it starts transmitting a response to the client (usually a web browser). Web servers can begin transmitting responses with dynamically-generated content before knowing the total size of that content. The size of each chunk is usually sent right before the chunk itself so that a client can tell when it has finished receiving data for that chunk. The data transfer is terminated by a final chunk of length zero.

If the above optimizations are included, prerequisites would normally include PHP5, PHP5-CURL package, and apache software.

PHP, which stands for PHP: Hypertext Preprocessor, is a general-purpose server-side scripting language originally designed for Web development to produce dynamic Web pages. It is one of the first developed server-side scripting languages to be embedded into an HTML source document rather than calling an external file to process data. The code is interpreted by a Web server with a PHP processor module which generates the resulting Web page. It also has evolved to include a command-line interface capability and can be used in standalone graphical applications. PHP can be deployed on most Web servers and also as a standalone shell on almost every operating system and platform free of charge. A competitor to Microsoft's Active Server Pages (ASP) server-side script engine and similar languages, PHP is installed on more than 20 million Web sites and 1 million Web servers. Software that uses PHP includes Joomla, Wordpress, MyBB, and Drupal.

Curl is a reflective object-oriented programming language for interactive web applications whose goal is to provide a smoother transition between formatting and programming. It makes it possible to embed complex objects in simple documents without needing to switch between programming languages or development platforms. It is a markup language like HTML—that is, plain text is shown as text. At the same time, Curl includes an object-oriented programming language that supports multiple inheritance. Curl applications are not required to observe the separation of information, style, and behavior that HTML, CSS, and JavaScript have imposed, although that style of programming can be used in Curl if desired.

ImageURIGen (Image Data URI generator) is a simple web service which generates, in one embodiment, base64 encoded image data URI response in JSON format for a given set of image URLs. The image URLs can be passed as HTTP GET or POST query string parameters.

Internally, in one embodiment, the web service reads the image URLs from the query string, makes CURL (HTTP) calls to the image hosting servers, does a base64 encoding on the CURL response, builds a JSON array and sends back the JSON response.

This technique would be extremely performance efficient when multiple HTTP calls need to be made from the browser to fetch dynamic images which cannot be previously sprited. Typical use cases would be displaying buddy images in a chat client or social applications, images of items uploaded by users in commerce sites, photo sharing sites etc. which are dynamic and decided on run time. Now with this technique, instead of making individual HTTP calls for images all of them can be combined into a single request to the ImageURIGen web service which will return the complete list of data URIs, which can then be set using JavaScript. Ideally all dynamic images coming below fold in the page can leverage this technique. Even servers can call this web service directly and build the page with URIs.

Sample Request and Response

A sample request may be:

http://hostedserver/services/urigen.PHP?params=
{&quot;images&quot;:[&quot;http://images.apple.com/mac/home/images/
productbrowser/macbookpro.jpg&quot;,&quot;http://p.ebaystatic.com/
aw/pics/logos/logoEbay_x45.gif&quot;]}

An elicited response may be:

```
{“data”:[
    {“url”:“http:\/\/images.apple.com\/mac\/home\/
images\/productbrowser\/macbookpro.jpg““,”uri“:”\/9j\/
4AAQSkZJRgABAgAAZABkAAD\/........5AQEBAQEBAQEBAQE
BAQEBAQEH\/\/z”},
    {“url”:“http:\/\/p.ebaystatic.com\/aw\/pics\/
logos\/logoEbay_x45.gif“,”uri“:”R01GODlhbgAtANUAALIAJpn
MAAAAmcz1.......B4NmdQZTJ5QUFBQUFFbEZUa1N1UW1DQw==”}
    ]
}
```

Enhancements

If an embodiment of the service makes all CURL calls sequentially, which is not an efficient way and can result in slow responsiveness, these calls could be more efficiently made in parallel using libraries like Pluton, and examples of which may be found at http://markdelany.github.com/Pluton/1.0/index.html.

The web service could be enhanced by a caching mechanism to avoid repetitive CURL calls for the same images again. The image URLs can be maintained in a hash with the corresponding URIs. Also a cache busting mechanism may be put in place based on the image response headers.

If images are hosted by the same publisher who hosts the web service then another enhancement may be to maintain the images in the same web server as the web service (or vice versa) and avoid CURL calls. Subsequent disk reads can also be avoided if caching mechanism is set up.

Cache headers sent in the final web service JSON response itself can be tweaked in accordance with the actual image cache headers to maximize the usage of browser cache.

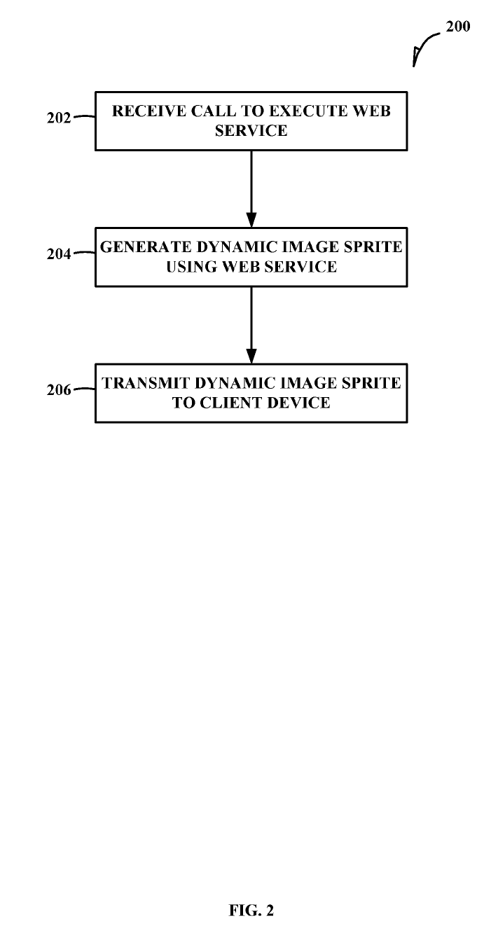

FIG. 2 illustrates an example method of generating a dynamic image sprite, according to some embodiments. At operation 202, a call is received from a client device to execute a web service after a web page is loaded by the web browser application. The call may include a plurality of image uniform resource identifiers (URI). The call may be received after a page load event is performed by a web browser application executing on the client device. At operation 204, at least one processor executing the web service may generate a dynamic image sprite using the image URIs. The dynamic image sprite may include a base-64 encoded image data URI scheme response in JavaScript Object Notation format. At operation 206, the dynamic image sprite is transmitted to the client device to enable the web browser to efficiently render the web page by reducing the number of HTTP requests issued by the web browser to retrieve images contained in the web page.

In some embodiments, generating the dynamic web sprite may include the web service generating Hypertext Transfer Protocol (HTTP) requests to at least one image hosting server to retrieve a plurality of images corresponding to the plurality of image URIs. The web service also may encode the plurality of images retrieved in response to the HTTP requests using a base-64 encoding scheme, thereby encoding binary data in an ASCII string format. The web service further may generate a JavaScript Object Notation (JSON) array containing the encoded images. The JSON array is a data structure that is an ordered collection of values separated by commas. In some embodiments, the image URIs may be the values contained in the JSON array.

In some embodiments, a Javascript engine in the web browser at the client device may deserialize the JSON array received from the web service. The Javascript engine may create images with the image URIs extracted from the JSON array and may display the images to the user.

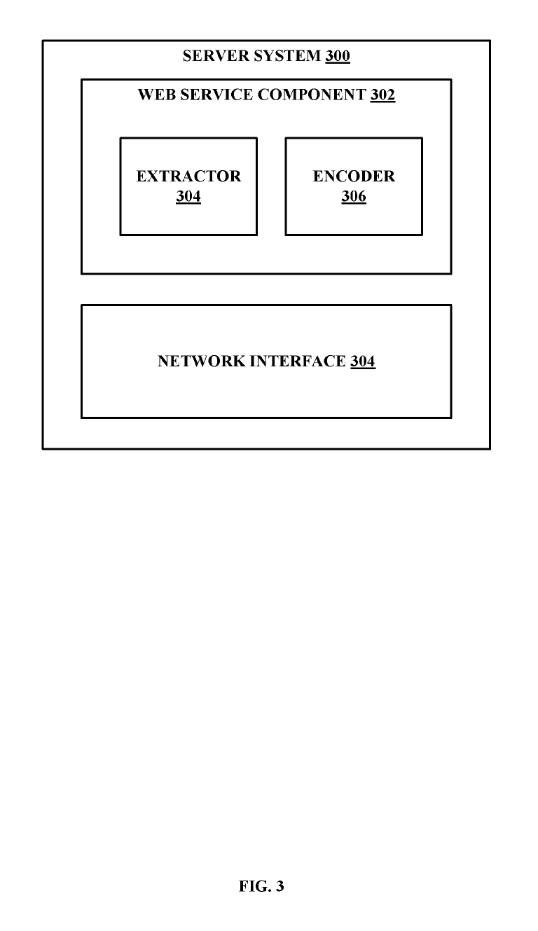

FIG. 3 illustrates a diagram of a system 300 for generating dynamic image sprites, according to some embodiments. The system 300 may include one or more processors contained in one or more machines, such as servers or other computing devices. In some embodiments, the system 300 may be one or more servers of the network-based publisher 102 of FIG. 1. For example, the system 300 may include or be part of the web server 120 and/or the application server 122. The one or more processors (not shown) may execute a web service component 302 that is configured to receive a call from a client device after a web page is loaded by the web browser application, where the call includes a plurality of image uniform resource identifiers (URI). The web service component 302 is further configured to generate a dynamic image sprite using the image URIs. In some embodiments, the dynamic image sprite is a base-64 encoded image data URI scheme response in JavaScript Object Notation format. The system 300 further may include a network interface 304 configured to transmit the dynamic image sprite to the client device.

In some embodiments, the web service component 302 may include an extractor 306 and an encoder 308. The extractor 306 may extract the image URIs from a query string contained in the call. In some embodiments, the query string includes the plurality of image URIs as parameters of the query string. In some embodiments, the encoder 308 may encode the plurality of images using a base-64 encoding scheme. The plurality of images may be retrieved in response to HTTP requests generated by the web service component 302 to at least one image hosting server using the plurality of image URIs.

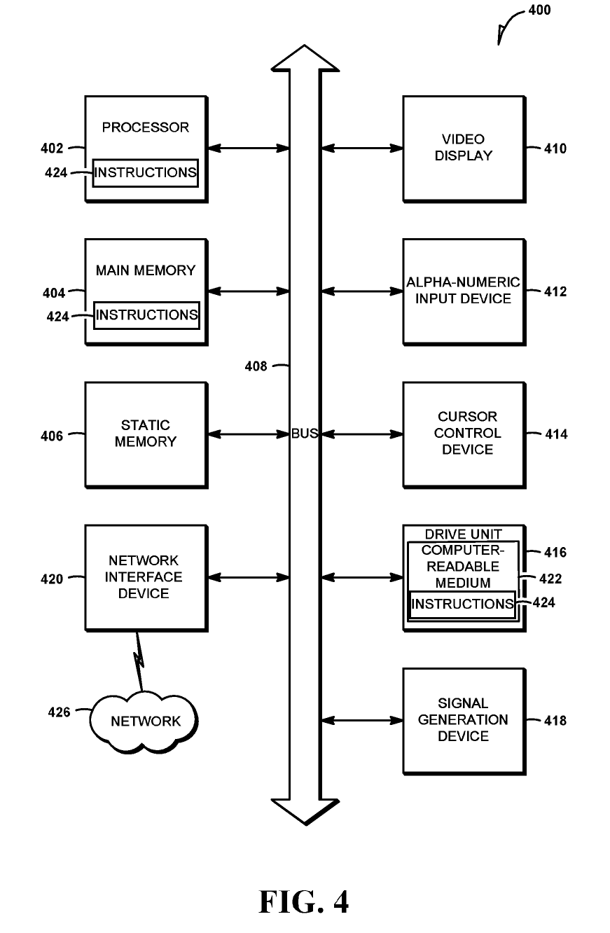

FIG. 4 shows a diagrammatic representation of machine in the exemplary form of a computer system 400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU) a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media. The software 424 may further be transmitted or received over a network 426 via the network interface device 420.

While the machine-readable medium 422 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable storage” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 400) or one or more hardware modules of a computer system (e.g., a processor 402 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 402 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a processor 402 configured using software, the processor 402 may be configured as respective different hardware modules at different times. Software may accordingly configure a processor 402, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 402 that are temporarily configured (e.g., by software, code, and/or instructions stored in a machine-readable medium) or permanently configured to perform the relevant operations. Whether temporarily or permanently configured, such processors 402 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 402 or processor-implemented (or computer-implemented) modules. Similarly, at least some of the operations of a method may be governed by instructions that are stored in a computer readable storage medium and executed by one or more processors 402 or processor-implemented (or computer-implemented) modules. The performance of certain of the operations may be distributed among the one or more processors 402, not only residing within a single machine, but deployed across a number of machines. In some example embodiments, the processors 402 may be located in a single location (e.g., within a home environment, an office environment or as a server farm), while in other embodiments the processors 402 may be distributed across a number of locations.

While the embodiment(s) is (are) described with reference to various implementations and exploitations, it will be understood that these embodiments are illustrative and that the scope of the embodiment(s) is not limited to them. In general, techniques for the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

What is claimed is:

1. A computer-implemented method comprising:
receiving a call from a client device to execute a web service after a web page is loaded by the web browser application, the call including a plurality of image uniform resource identifiers (URI);
generating, by at least one processor executing the web service, a dynamic image sprite using the image URIs, the dynamic image sprite comprising an encoded image data URI scheme response; and
transmitting the dynamic image sprite to the client device.

2. The method of claim 1 wherein the dynamic image sprite comprises a base-64 encoded image data and the URI scheme response is in JavaScript Object Notation format.

3. The computer-implemented method of claim 1, wherein generating the dynamic image sprite comprises:
generating, by the at least one processor executing the web service, Hypertext Transfer Protocol (HTTP) requests to at least one image hosting server to retrieve a plurality of images corresponding to the plurality of image URIs;
encoding, by the at least one processor executing the web service, the plurality of images retrieved in response to the HTTP requests; and
generating, by the at least one processor executing the web service, an array containing the encoded images.

4. The computer-implemented method of claim 3 wherein the encoding is accomplished using a base-64 encoding scheme and the array is a JavaScript Object Notation array.

5. The computer-implemented method of claim 1, wherein the plurality of image URIs are passed in the call as parameters of a query string and further comprising extracting the image URIs from the query string.

6. A system comprising:
at least one processor;
a web service component, implemented by the at least one processor, configured to:
receive a call from a client device after a web page is loaded by the web browser application, the call including a plurality of image uniform resource identifiers (URI); and
generate a dynamic image sprite using the image URIs, the dynamic image sprite comprising an encoded image data URI scheme response; and
a network interface configured to transmit the dynamic image sprite to the client device.

7. The system of claim 6 wherein the dynamic image sprite comprises a base-64 encoded image data and the URI scheme response is in JavaScript Object Notation format.

8. The system of claim 6, wherein the web service component comprises:
an extractor configured to extract the image URIs from a query string contained in the call, the query string including the plurality of image URIs as parameters; and
an encoder configured to encode the plurality of images, the plurality of images retrieved in response to HTTP requests generated by the web service component to at least one image hosting server using the plurality of image URIs,
wherein the web service component is further configured to generate an array containing the encoded images.

9. The system of claim 8 wherein the encoding is accomplished using a base-64 encoding scheme and the array is a JavaScript Object Notation array.

10. The system of claim 6, wherein the plurality of image URIs are passed in the call as parameters of a query string and further comprising extracting the image URIs from the query string.

11. A machine-readable storage device storing a set of instructions that, when executed by at least one processor, causes the at least one processor to perform operations comprising:
receiving a call from a client device to execute a web service after a web page is loaded by the web browser application, the call including a plurality of image uniform resource identifiers (URI);
generating, by at one processor executing the web service, a dynamic image sprite using the image URIs, the dynamic image sprite comprising encoded image data URI scheme response; and
transmitting the dynamic image sprite to the client device.

12. The machine-readable storage device of claim 11 wherein the dynamic image sprite comprises a base-64 encoded image data and the URI scheme response is in JavaScript Object Notation format.

13. The machine-readable storage device of claim 12, wherein generating the dynamic image sprite comprises:
generating, by the at least one processor executing the web service, Hypertext Transfer Protocol (HTTP) requests to at least one image hosting server to retrieve a plurality of images corresponding to the plurality of image URIs;
encoding, by the at least one processor executing the web service, the plurality of images retrieved in response to the HTTP requests; and
generating, by the at least one processor executing the web service, an array containing the encoded images.

14. The machine-readable storage device claim 13 wherein the encoding is accomplished using a base-64 encoding scheme and the array is a JavaScript Object Notation array.

15. The machine-readable storage device of claim 11, wherein the plurality of image URIs are passed in the call as parameters of a query string and further comprising extracting the image URIs from the query string.

16. A computer-implemented method comprising:
receiving a call from a client device to execute a web service after a web page is loaded by the web browser application, the call including a plurality of image uniform resource identifiers (URI);
generating, by at one processor executing the web service, a dynamic image sprite using the image URIs, the dynamic image sprite comprising a base-64 encoded image data URI scheme response in JavaScript Object Notation format; and
transmitting the dynamic image sprite to the client device.

17. A machine-readable storage device storing a set of instructions that, when executed by at least one processor, causes the at least one processor to perform operations comprising:
receiving a call from a client device to execute a web service after a web page is loaded by the web browser application, the call including a plurality of image uniform resource identifiers (URI);
generating, by at one processor executing the web service, a dynamic image sprite using the image URIs, the dynamic image sprite comprising a base-64 encoded image data URI scheme response in JavaScript Object Notation format; and
transmitting the dynamic image sprite to the client device.

18. A system comprising:
web service means including first means for receiving a call from a client device after a web page is loaded by the web browser application, the call including a plurality of image uniform resource identifiers (URI), and second means for generating a dynamic image sprite using the image URIs, the dynamic image sprite comprising an encoded image data URI scheme response; and
network interface means for transmitting the dynamic image sprite to the client device.

19. The system of claim 18 wherein the dynamic image sprite comprises a base-64 encoded image data and the URI scheme response is in JavaScript Object Notation format.

20. The system of claim 18, wherein the web service means further comprises:
extractor means for extracting the image URIs from a query string contained in the call, the query string including the plurality of image URIs as parameters; and
encoder means for encoding in a base-64 encoding scheme the plurality of images, the plurality of images retrieved in response to HTTP requests generated by the web service component to at least one image hosting server using the plurality of image URIs,
wherein the web service component is further configured to generate JavaScript Object Notation array containing the encoded images.
